(19) United States
(12) Patent Application Publication
(10) Pub. No.: US 2014/0357475 A1
(43) Pub. Date: Dec. 4, 2014

(54) Systems and Methods Using Cu-Mn Spinel Catalyst on Varying Carrier Material Oxides for TWC Applications

(71) Applicants: Zahra Nazarpoor, Camarillo, CA (US); Stephen J. Golden, Santa Barbara, CA (US)

(72) Inventors: Zahra Nazarpoor, Camarillo, CA (US); Stephen J. Golden, Santa Barbara, CA (US)

(73) Assignee: CDTI, Ventura, CA (US)

(21) Appl. No.: 13/904,255

(22) Filed: May 29, 2013

(51) Int. Cl. B01J 29/78; B01J 23/889

(52) U.S. Cl. CPC B01J 29/78; B01J 23/8892
USPC 502/73; 502/324; 502/302; 502/304; 502/87

(57) ABSTRACT

Disclosed here are variations of carrier material oxide formulations to create Cu—Mn spinel, where the formulations may include Ti₁₋ₓNbₓO₂, TiO₂, SiO₂, Doped alumina, Nb₂O₅—ZrO₂, Nb₂O₅—ZrO₂—CeO₂, Doped ZrO₂ and combinations thereof. The formation of type of Cu—Mn oxide phase depends on type of carrier material oxide. The crystallite size of Cu—Mn spinel, NO and CO conversion rate of Cu—Mn Spinel may vary according to the carrier material oxide and condition treatment used to form the spinel during co-precipitation method.

### CROSS-REFERENCE TO RELATED APPLICATIONS

N/A

### BACKGROUND

1. Technical Field

This disclosure relates generally to catalytic converters, and, more particularly, to materials of use in catalyst systems.

2. Background Information

Emissions standards seek the reduction of a variety of materials in exhaust gases, including unburned hydrocarbons (HC), carbon monoxide (CO), and nitrogen oxides (NO). In order to meet such standards, catalyst systems able to convert such materials present in the exhaust of any number of mechanisms are needed.

To this end, there is a continuing need to provide materials able to perform in a variety of environments, which may vary in a number ways, including oxygen content and the temperature of the gases undergoing treatment.

### SUMMARY

Zero platinum group metals (ZPGM) catalyst systems are disclosed. Materials suitable to use as variations of carrier material oxide to form Cu—Mn spinel may include TiO₂, doped TiO₂, Ti₁₋ₓNbₓO₂, SiO₂, Alumina and doped alumina, ZrO₂ and doped ZrO₂, Nb₂O₅—ZrO₂, Nb₂O₅—ZrO₂—CeO₂ and combinations thereof.

Suitable methods for preparing Cu—Mn spinel containing these materials may include a co-precipitation method or any other suitable known in the art chemical techniques, deposition methods and treatment systems may be employed in order to form the disclosed ZPGM catalyst.

Metal salt solutions suitable for the use in the co-precipitation process described in this disclosure may include solutions of Copper Nitrate (CuNO₃) or Copper acetate and Manganese Nitrate (MnNO₃) or Manganese acetate in any suitable solvent.

The type of Cu—Mn spinel phase and the crystallite size may vary depending on the type of carrier material oxide used and the treatment condition the final catalyst may receive. In addition, the effect of aging on the nature of Cu—Mn spinel depends on the type of carrier metal oxides.

The disclosed Cu—Mn spinel catalyst may be formed on a substrate, where the substrate may be of any suitable material, including cordierite and may be used for TWC application.

Numerous other aspects, features and advantages of the present disclosure may be made apparent from the following detailed description, taken together with the drawing figures.

### BRIEF DESCRIPTION OF THE DRAWINGS

The present disclosure can be better understood by referring to the following figures. The components in the figures are not necessarily to scale, emphasis instead being placed upon illustrating the principles of the invention. In the figures, any reference numerals designate corresponding parts throughout different views.

FIG. 1 shows co-precipitation method for the powder synthesis of Stoichiometric Cu—Mn spinel, according to an embodiment

FIG. 2 shows the X-ray diffraction (XRD) peaks of bare ZrO2-Nb2O5, according to an embodiment.

FIG. 3 s shows XRD phase analysis including diffraction peaks of powder prepared in example#1, according to an embodiment.

FIG. 4 illustrates the XRD phase analysis of the same powder of example#1 after aging, according to an embodiment.

FIG. 5 shows the XRD phase analysis peaks of fresh powder sample prepared in example#1 after reaction, according to an embodiment.

FIG. 6 illustrates (XRD) peaks of bare Nb2O5-ZrO2-CeO2, according to an embodiment.

FIG. 7 shows the XRD phase analysis peaks of powder prepared in example#2 when the powder is fresh, according to an embodiment.

FIG. 8 shows the XRD phase analysis of the same powder of example#2 after aging, according to an embodiment.

FIG. 9 shows the XRD phase analysis peaks of powder prepared in example#3 when the powder is fresh, according to an embodiment.

FIG. 10 shows the XRD phase analysis of the same powder of example#3 after aging, according to an embodiment.

FIG. 11 shows the comparison of crystallite size of Cu—Mn mixed phase formed on samples of example#1, example#2 and example#3, according to an embodiment.

FIG. 12 shows CO light-off test under rich exhaust conditions for samples of example #1 , example#2 and example#3, according to an embodiment.

FIG. 13 illustrates NO light-off test under rich exhaust conditions for samples of example #1 , example#2 and example#3, according to an embodiment.

FIG. 14 shows NO light-off test under rich exhaust conditions for samples of example #1 , example#2 and example#3 after aging, according to an embodiment.

### DETAILED DESCRIPTION

### Definitions

As used here, the following terms have the following definitions:

“Exhaust” refers to the discharge of gases, vapor, and fumes that may include hydrocarbons, nitrogen oxide, and/or carbon monoxide.

“R Value” refers to the number obtained by dividing the reducing potential by the oxidizing potential.

“Rich Exhaust” refers to exhaust with an R value above 1.

“Lean Exhaust” refers to exhaust with an R value below 1.

“Conversion” refers to the chemical alteration of at least one material into one or more other materials.

“Catalyst” refers to one or more materials that may be of use in the conversion of one or more other materials.

“Carrier Material Oxide (CMO)” refers to support materials used for providing a surface for at least one catalyst.

“Oxygen Storage Material (OSM)” refers to a material able to take up oxygen from oxygen rich streams and able to release oxygen to oxygen deficient streams.

“Three Way Catalyst (TWC)” refers to a catalyst suitable for use in converting at least hydrocarbons, nitrogen oxide, and carbon monoxide.

“Oxidation Catalyst” refers to a catalyst suitable for use in converting at least hydrocarbons and carbon monoxide.

“Wash-coat” refers to at least one coating including at least one oxide solid that may be deposited on a substrate.

“Over-coat” refers to at least one coating that may be deposited on at least one wash-coat or impregnation layer.

“Zero Platinum Group (ZPGM) Catalyst” refers to a catalyst completely or substantially free of platinum group metals.

“Platinum Group Metals (PGMs)” refers to platinum, palladium, ruthenium, iridium, osmium, and rhodium.

### DESCRIPTION OF THE DRAWINGS

Disclosed here are catalyst materials that may be of use in the conversion of exhaust gases, according to an embodiment.

The present disclosure is here described in detail with reference to embodiments illustrated in the drawings, which form a part hereof. In the drawings, which are not necessarily to scale or to proportion, similar symbols typically identify similar components, unless context dictates otherwise. Other embodiments may be used and/or other changes may be made without departing from the spirit or scope of the present disclosure. The illustrative embodiments described in the detailed description are not meant to be limiting of the subject matter presented herein.

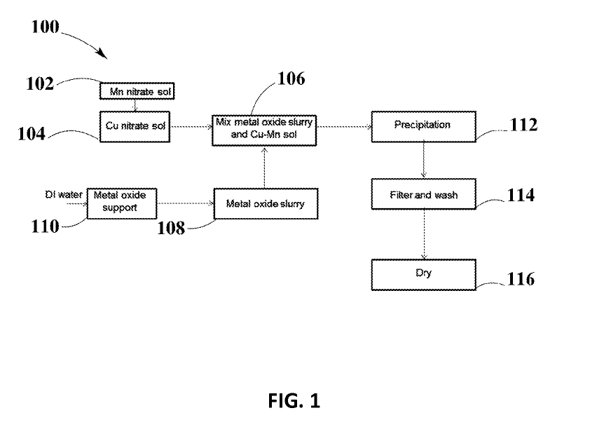

FIG. 1 shows co-precipitation method 100 for the powder synthesis of Stoichiometric Cu—Mn spinel with general formula of Cu_{1.0}Mn_{2.0}O₄ on different carrier oxide supports. The preparation may begin by mixing the appropriate amount of Mn nitrate solution 102 and Cu nitrate solution 104, where the suitable copper loadings may include loadings in a range of 10 to 20 percent by weight and suitable manganese loadings may include loadings in a range of 10 to 30 percent by weight. The next step may mix 106 the Cu—Mn solution with slurry of carrier material oxide 110 support.

Co-precipitation method 100 may be created by addition of appropriate amount of one or more of NaOH solution, Na2CO3 solution, and ammonium hydroxide (NH4OH) solution. The pH of Cu—Mn carrier oxide support slurry may be adjusted at the range of 7-9 and the slurry may be aged for a period of time of about 12 to 24 hours, while keep stirring. This precipitation may be formed over a slurry including at least one suitable carrier material oxide 110, where the slurry may include any number of additional suitable carrier material oxides 110, and may include one or more suitable Oxygen Storage Materials. After precipitation 112, metal oxide slurry 108 may then undergo filtering and washing 114, where the resulting material may be dried 116 and may later be calcined at any suitable temperature of about 300° C. to about 600° C., preferably about 500° C. for about 5 hours.

Metal salt solutions suitable for use in co-precipitation method 100 described above may include solutions of Copper Nitrate (CuNO₃) or Copper acetate and Manganese Nitrate (MnNO₃) or Manganese acetate in any suitable solvent.

Other methods suitable for preparing catalysts similar to those described above may include sol-gel methods and templating methods, including polymeric templating agent such as polyethylene glycol, polyvinyl alcohol, poly(N-vinyl-2pyrrolidone)(PVP), polyacrylonitrile, polyacrylic acid, multilayer polyelectrolyte films, poly-siloxane, oligosaccharides, poly(4-vinylpyridine), poly(N,Ndialkylcarbodiimide), chitosan, hyper-branched aromatic polyamides and other suitable polymers.

Cu—Mn spinel catalyst may be formed on a substrate, where the substrate may be of any suitable material, including cordierite. The washcoat may include one or more carrier material oxide 110 and may also include one or more OSMs. Cu—Mn spinel may be precipitated 112 on said one or more carrier material oxide 110 or combination of carrier material oxide 110 and oxygen storage material, where the catalyst may be synthesized by any suitable chemical technique, including co-precipitation method 100. The milled Cu—Mn spinel catalyst and carrier material oxide 110 may then be deposited on a substrate, forming an overcoat, where the overcoat may undergo one or more heat treatments.

Variations of Carrier Material Oxide

Various types of carrier material oxide 110 may be useful for supporting Cu—Mn spinel catalyst. Carrier material oxide 110 may include TiO₂, doped TiO₂, Ti₁₋ₓNbₓO₂, SiO₂, Al₂O₃ and doped Al₂O₃, ZrO₂ and doped ZrO₂ (for example Pr-doped ZrO₂), Nb₂O₅—ZrO₂ and Nb₂O₅—ZrO₂—CeO₂ and combinations thereof.

Types of carrier material oxide 110 may directly affect the type of Cu—Mn oxide phase and structure. This may influence the formation of spinel phase and also size of crystallite Cu—Mn spinel.

### EXAMPLES

Example #1 A powder Cu—Mn spinel with a general formula of Cu1.0Mn2.0O4 is formed on Nb₂O₅-ZrO₂ support. The co-precipitation method 100 shown in FIG. 1 was used to prepare this powder. Nb₂O₅—ZrO₂ is used as carrier material oxide 110 which contains ZrO₂ from 60 to 80 percent by weight, preferably 75 percent by weight and Nb₂O₅ from 20 to 40 percent by weight, preferably 25 percent by weight. In case of aged samples, the powder sample was treated at 900° C. for 4 hours under dry air condition.

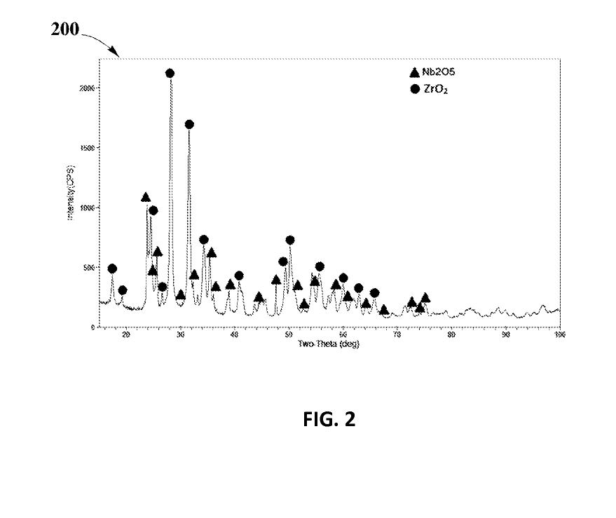

FIG. 2 shows the X-ray diffraction (XRD) peaks of bare ZrO2-Nb2O5 200 which is used as carrier material oxide 110 in preparation of powder Cu—Mn spinel of example #1. The solid triangles are assigned to Nb₂O₅ and the circles assigned to ZrO₂.

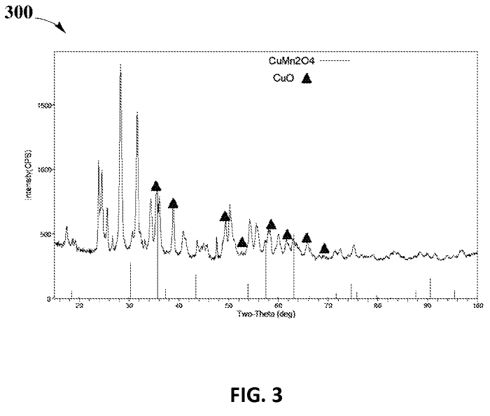

FIG. 3 shows XRD phase analysis 300 including diffraction peaks of powder prepared in example#1 when the powder is fresh. XRD phase analysis 300 shows the formation of CuMn2O4 spinel (solid line) and the presence of free CuO phase (solid triangle). The remaining diffraction peaks in FIG. 3 corresponds to Nb₂O₅—ZrO₂ support. The XRD phase analysis 300 result test shows the formation of mixed CuO and Cu—Mn spinel at fresh sample prepared in example#1. The average crystalline size of this mixed oxide phase was measured at approximately 11 nm.

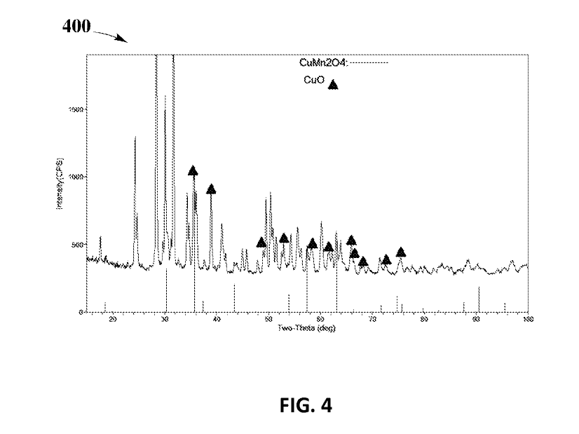

FIG. 4 illustrates the XRD phase analysis 400 of the same powder of example#1 after aging at 900° C. for about 4 hours. The XRD phase analysis 400 of aged samples shows the stability of CuMn₂O₄ and CuO after aging, and no new phase formed. However, decreasing the full width at half maximum (FWHM) of mixed metal oxides phase (having sharper peaks) is evidence of increasing the crystalline size of Cu oxide and Cu—Mn spinel mixed phase. The average crystallite size of this mixed oxide phase was measured at approximately 18 nm.

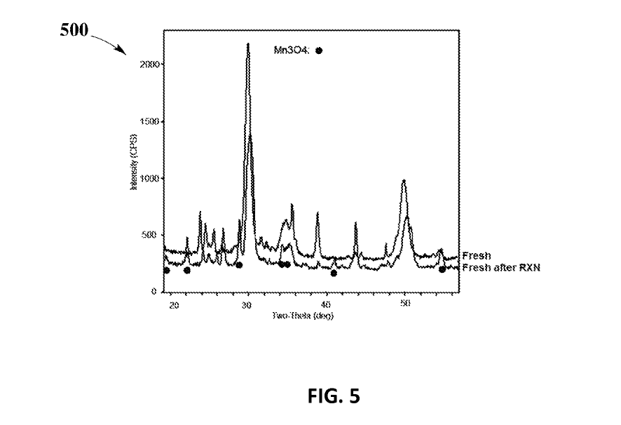

FIG. 5 shows the XRD phase analysis 500 peaks of fresh powder sample prepared in example#1 after placing under rich exhaust condition. The fresh sample undergoes a light-off test with a rich gas stream at R-value=1.224 from temperature of 100° C. to 600° C. FIG. 5 compares the XRD peaks of fresh powder sample before and after reaction. The position of Cu—Mn spinel diffraction peaks (shown in FIG. 3) shows the same angles after reaction. Therefore, XRD phase analysis 500 shows the stability of Cu—Mn spinel phase during reaction. However, the results show the formation of Mn₃O₄ during reaction.

In Example #2 A powder Cu—Mn spinel with a general formula of Cu1.0Mn2.0O4 is formed on Nb₂O₅—ZrO₂—CeO₂ support. The co-precipitation method 100 shown in FIG. 1 was used for preparation of this powder. Nb₂O₅—ZrO₂—CeO₂ is used as carrier material oxide 110 which contains ZrO₂ from 50 to 70 percent by weight, preferably 60 percent by weight and Nb₂O₅ from 10 to 30 percent by weight, preferably 20 percent by weight and CeO₂ from 10 to 30 percent by weight, preferably 20 percent by weight. In case of aged samples, the powder sample was treated at 900° C. for 4 hours under dry air condition.

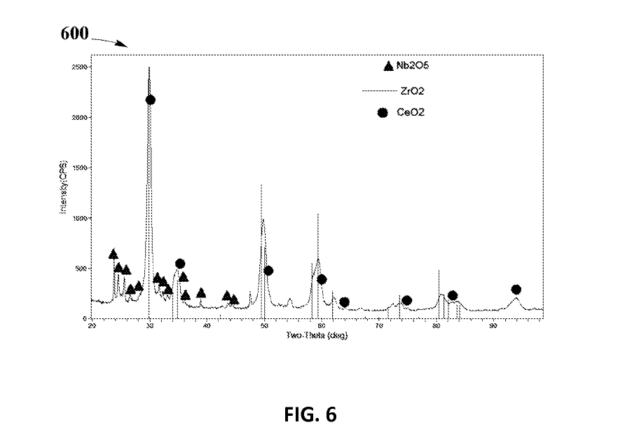

FIG. 6 shows the X-ray diffraction (XRD) peaks of bare Nb2O5-ZrO2-CeO2 600 which is used as carrier material oxide 110 in preparation of powder Cu—Mn spinel of example #2. The solid triangles are assigned to Nb₂O₅ phase, the solid circles assigned CeO₂ phase, and solid line assigned to ZrO₂.

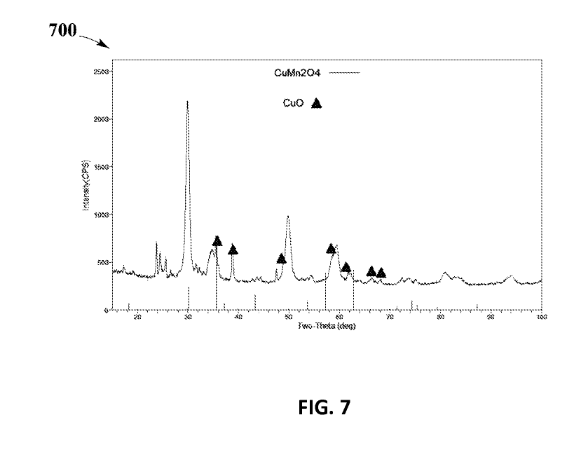

FIG. 7 shows the XRD phase analysis 700 peaks of powder prepared in example #2 when the powder is fresh. XRD phase analysis 700 shows the formation of CuMn2O4 spinel (solid line) and the presence of free CuO phase (solid triangle). The remaining diffraction peaks in FIG. 7 corresponds to Nb₂O₅—ZrO₂—CeO₂ support. The XRD phase analysis 700 result test shows the formation of mixed CuO and Cu—Mn spinel at fresh sample prepared in example #2. The average crystallite size of this mixed oxide phase was measured at approximately 8 nm.

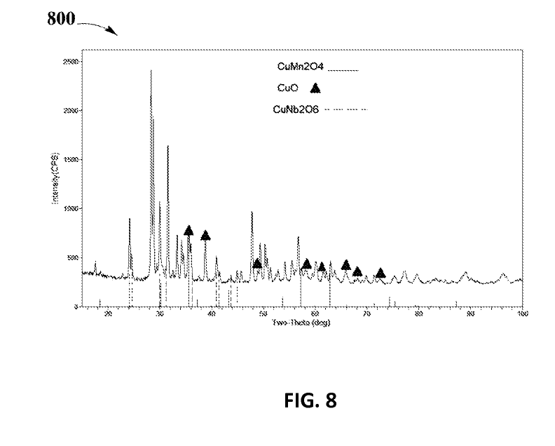

FIG. 8 shows the XRD phase analysis 800 of the same powder of example #2 after aging at 900° C. for about 4 hours. The XRD phase analysis 800 of aged samples shows the stability of CuMn₂O₄ and CuO after aging. However, a new copper niobium oxide phase is formed in the powder of example #2 on Nb₂O₅—ZrO₂—CeO₂ support after aging. In addition, decreasing the full width at half maximum (FWHM) of mixed metal oxides phase (having sharper peaks) is evidence of increasing the crystalline size of mixed oxide phase in this sample. The average crystallite size of this mixed oxide phase increased to approximately 17 nm.

In Example #3 A powder Cu—Mn spinel with a general formula of Cu1.0Mn2.0O4 is formed on Pr-dopped ZrO₂. The co-precipitation method 100 shown in FIG. 1 was used for preparation of this powder. ZrO₂—Pr₆O₁₁ is used as carrier material oxide 110 which contains ZrO₂ from 80 to 95 percent by weight, preferably 90 percent by weight and Pr₆O₁₁ from 5 to 20 percent by weight, preferably 10 percent by weight. In case of aged samples, the powder sample was treated at 900° C. for 4 hours under dry air condition.

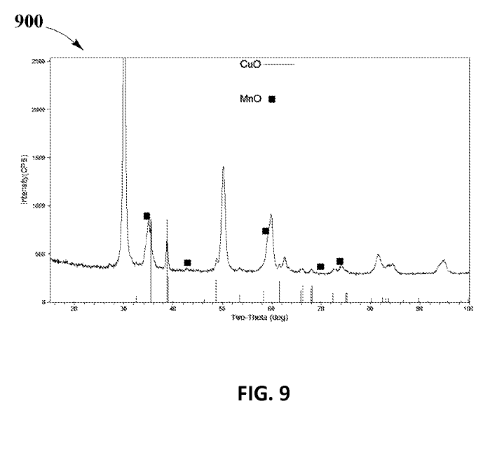

FIG. 9 shows the XRD phase analysis 900 peaks of powder prepared in example #3 when the powder is fresh. XRD phase analysis 900 shows no Cu—Mn spinel phase formed on Pr-doped ZrO₂ support. FIG. 9 shows the formation of mixed CuO and MnO phase on the fresh powder sample of example #3. The remaining diffraction peaks corresponds to ZrO₂ from the support. The average crystallite size of this mixed oxide phase was measured at approximately 8 nm.

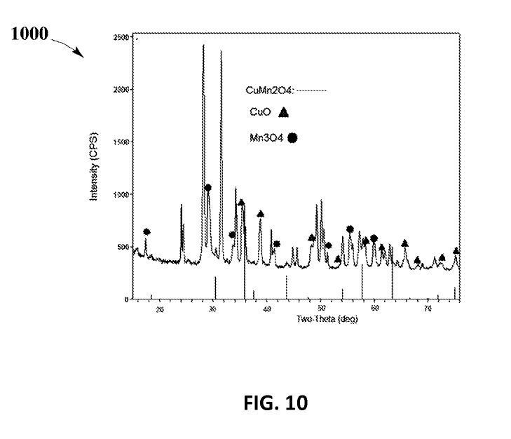

FIG. 10 shows the XRD phase analysis 1000 of the same powder of example #3 after aging at 900° C. for about 4 hours. The XRD phase analysis 1000 of aged samples shows the formation of Cu—Mn spinel phase (solid line) after aging on Pr-doped ZrO₂ support. However, in addition to Cu—Mn spinel phase (solid line) and CuO phase (solid triangle), the Mn₃O₄ phase (solid circle) formed after aging. The remaining diffraction peaks in FIG. 10 corresponds to ZrO₂ from the support. The average crystallite size of this mixed oxide phase is approximately 10 nm.

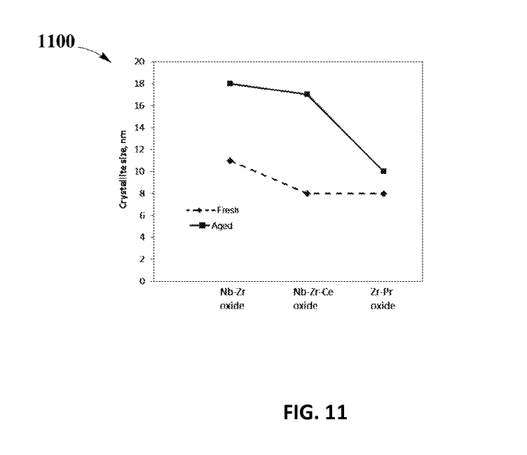

FIG. 11 shows the comparison 1100 of crystallite size of Cu—Mn mixed 106 phases formed on samples of example #1, example #2 and example #3. FIG. 11 compares the crystallite size of fresh and aged samples. Each variation of carrier material oxide 110 may provide different crystallite sizes, which may also depend on the condition treatment used to form the Cu—Mn spinel. As shown in FIG. 11, the increasing of crystallite size of Cu—Mn mixed 106 phases is more significant for Nb₂O₅—ZrO₂ and Nb₂O₅—ZrO₂—CeO₂ supports.

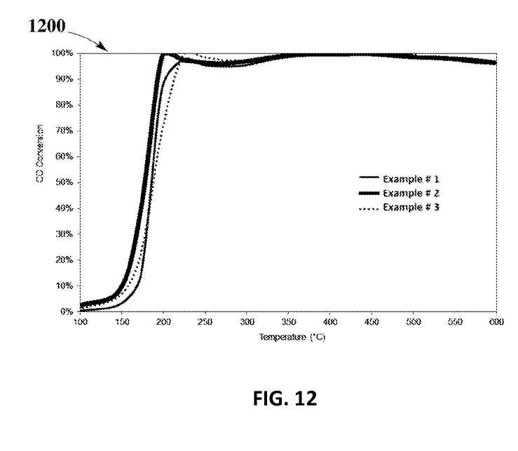

FIG. 12 shows CO light-off test 1200 under rich exhaust conditions for samples of example #1, example #2 and example #3. All samples are fresh and temperature increased from 100° C. to 600° C. under rich exhaust at R-value=1.224. Propylene (C3H6) is used as feed hydrocarbon. FIG. 12 shows T50 of CO at 185° C., 178° C., and 188° C. for powder sample of example #1, example #2, and example #3, respectively. The results show that the type of carrier metal oxide has no significant effect on CO conversion; however, Nb₂O₅—ZrO₂—CeO₂ support shows slightly improvement in CO conversion.

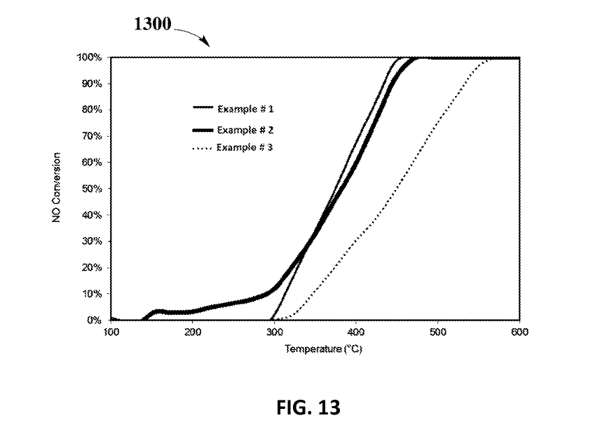

FIG. 13 illustrates NO light-off test 1300 under rich exhaust conditions for samples of example #1, example #2 and example #3. All samples are fresh and reaction temperature increased from 100° C. to 600° C. under rich exhaust at R-value=1.224. Propylene (C3H6) is used as feed hydrocarbon. FIG. 13 shows T50 of NO at 375° C., 383° C., and 450° C. for powder sample of example #1, example #2, and example #3, respectively. The results show that the type of support has significant effect on type of Cu and Mn oxide phase formed, and therefore on NO conversion. Nb₂O₅—ZrO₂—CeO₂ and Nb₂O₅—ZrO₂ supports show improvement in NO conversion. This can be related to formation of Cu—Mn spinel in these samples when they are fresh. Absence of Cu—Mn spinel phase on Pr-doped ZrO₂ (example #3) results in significant increase of T50 of NO conversion in this sample under fresh condition.

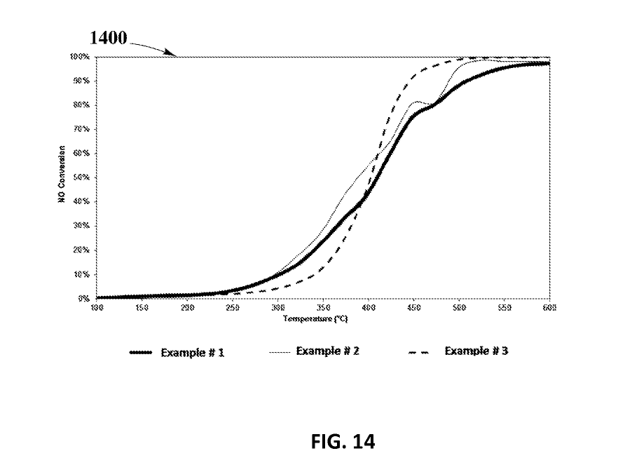

FIG. 14 shows NO light-off test 1400 under rich exhaust conditions for samples of example #1, example #2 and example #3 after aging. All samples are aged at 900° C. for 4 hours and the reaction temperature increased from 100° C. to 600° C. under rich exhaust at R-value=1.224. Propylene (C3H6) is used as feed hydrocarbon. FIG. 14 shows T50 of NO at 410° C., 385° C., and 403° C. for powder sample of example #1, example #2, and example #3, respectively. The results show that the type of support influences the NO conversion after aging. The overall NO conversion of samples of example #1 and example #2 decreased after aging and this is because of increasing the crystallite size of Cu—Mn spinel phase. However, the overall NO conversion of sample of example #3 improved after aging. The improvement can be related to formation of Cu—Mn spinel phase on Pr-doped ZrO₂ after aging.

What is claimed is:

1. A zero platinum group metals (ZPGM) catalyst system, comprising:
a substrate;
a washcoat suitable for deposition on the substrate, comprising at least one oxide solid selected from the group consisting of at least one of a carrier material oxide, and a first ZPGM catalyst; and
an overcoat suitable for deposition on the substrate, comprising at least one overcoat oxide solid selected from the group consisting of at least one of a carrier material oxide, and a second ZPGM catalyst;
wherein at least one of the first catalyst and the second catalyst comprises at least one spinel structured compound having the formula AB₂O₄, wherein each of A and B is selected from the group consisting of at least one of copper and manganese; and
wherein one of the at least one carrier material oxide in selected from the group consisting of TiO₂, doped TiO₂, Ti1-xNbxO₂, SiO₂, alumina, doped alumina, ZrO₂, doped ZrO₂, Nb₂O₅—ZrO₂, Nb₂O₅—ZrO₂—CeO₂, and combinations thereof.

2. The ZPGM catalyst system of claim 1, wherein the substrate comprises cordierite.

3. The ZPGM catalyst system of claim 1, wherein the spinel structured compound is prepared by co-precipitation.

4. The ZPGM catalyst system of claim 3, wherein a metal salt solution is used in the co-precipitation process and is selected from the group consisting of copper nitrate, copper acetate, manganese nitrate, manganese acetate, and combinations thereof.

5. The ZPGM catalyst system of claim 1, wherein the crystallite size of the spinel structured compound is dependent on the carrier material oxide.

6. The ZPGM catalyst system of claim 5, wherein the crystallite size of the spinel structured compound is about 18 nm.

7. The ZPGM catalyst system of claim 5, wherein the crystallite size of the spinel structured compound is about 8 nm.

8. The ZPGM catalyst system of claim 1, wherein the spinel structured compound is aged.

9. The ZPGM catalyst system of claim 8, wherein the spinel structured compound is stable.

10. The ZPGM catalyst system of claim 1, wherein the phase of the spinel structured compound is dependent on the carrier material oxide.

11. The ZPGM catalyst system of claim 1, wherein an NO conversion rate corresponds to the carrier material oxide.

12. The ZPGM catalyst system of claim 1, wherein a T50 conversion temperature for carbon monoxide is less than about 200 degrees Celsius.

13. The ZPGM catalyst system of claim 1, wherein a T50 conversion temperature for carbon monoxide is less than about 175 degrees Celsius.

14. The ZPGM catalyst system of claim 1, wherein the at least one carrier material oxide comprises Nb₂O₅—ZrO₂.

15. The ZPGM catalyst system of claim 14, wherein the ZrO₂ is about 60% to about 80% by weight of the at least one carrier material oxide.

16. The ZPGM catalyst system of claim 14, wherein the ZrO₂ is about 75% by weight of the at least one carrier material oxide.

17. The ZPGM catalyst system of claim 1, wherein the at least one carrier material oxide is heated to about 900° C. for about 4 hours.

18. The ZPGM catalyst system of claim 1, wherein the doped ZrO₂comprises praseodymium.

19. The ZPGM catalyst system of claim 18, wherein the ZrO₂ is about 80% to about 95% by weight of the at least one carrier material oxide.

20. The ZPGM catalyst system of claim 18, wherein the ZrO is about 90% by weight of the at least one carrier material oxide.
